(19) United States
(12) Patent Application Publication
(10) Pub. No.: US 2017/0111889 A1
(43) Pub. Date: Apr. 20, 2017

(54) METHOD AND EQUIPMENT FOR DATA TRANSMISSION ON UNLICENSED BAND

(71) Applicant: Samsung Electronics Co., Ltd, Gyeonggi-do (KR)

(72) Inventors: Yingyang Li, Beijing (CN); Chengjun Sun, Beijing (CN); Jingxing Fu, Beijing (CN)

(21) Appl. No.: 15/311,840

(22) PCT Filed: May 14, 2015
(86) PCT No.: PCT/KR2015/004827

§ 371 Date: Nov. 16, 2016

(30) Foreign Application Priority Data
May 16, 2014 (CN) 201410209277.5
Sep. 2, 2014 (CN) 201410443970.9
Sep. 12, 2014 (CN) 201410466698.6

(51) Int. Cl. H04W 72/04; H04L 5/00; H04L 27/26

(52) U.S. Cl. CPC H04W 72/042; H04W 72/0446; H04L 27/2601; H04L 5/0053; H04L 5/0096; H04W 84/12

(57) ABSTRACT

The present invention provides a method for data transmission on an unlicensed band, comprising the steps of: receiving, by UE, configuration information, the configuration information configuring a cell where the UE works on an unlicensed and; and, receiving, by the UE, control information, and performing data transmission on the unlicensed band according to the control information. The present application further discloses a method for data transmission on an unlicensed band, UE and a base station. By the technical solutions provided by the present invention, a wireless channel can be reserved for the data transmission of UE on an unlicensed band, and the data transmission of the UE on the unlicensed band and the frequency occupation of a WiFi system are coordinated, so that the mutual interference between the data transmission of the UE on the unlicensed band and the WiFi system is avoided.

### TECHNICAL FIELD

The present invention relates to wireless communication systems, and particularly to a method and equipment for data transmission on an unlicensed band based on a long term evolution (LTE) system.

### BACKGROUND ART

A long term evolution (LTE) system of a 3GPP standardization organization supports two duplex modes, i.e., time division duplex (TDD) and frequency division duplex (FDD). As shown in FIG. 1, for an FDD system, each wireless frame is 10 ms in length and contains 10 subframes each 1 ms in length, and each subframe is formed of two continuous time slots each 0.5 ms in length, that is, the kth subframe includes a time slot 2k and a time slot 2k+1. As shown in FIG. 2, for a TDD system, each wireless frame 10 ms in length is equally divided into two half-frames each 5 ms in length. Each half-frame contains 8 time slots each 0.5 ms in length and 3 special fields, i.e., a downlink pilot time slot (DwPTS), a guard period (GP) and an uplink pilot time slot (UpPTS). The sum of the length of the 3 special fields is 1 ms. Each subframe is formed of two continuous time slots, that is, the kth subframe includes a time slot 2k and a time slot 2k+1, where k=0, 1, . . . , 9. A downlink transmission time interval (TTI) is defined in a subframe.

The TDD system supports 7 types of uplink/downlink configurations, as shown in Table 1. Here, D is a downlink subframe, U is an uplink subframe, and S is a special subframe containing the above 3 special fields.

TABLE 1
Uplink/downlink configuration of LTE TDD

| Config- | Cycle of | | | | | | | | | | |
|---|---|---|---|---|---|---|---|---|---|---|---|
| uration | transformation | Subframe No. | | | | | | | | | |
| No. | point | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

The first n OFDM symbols of each downlink subframe may be used for transmitting downlink control information, and the downlink control information includes a physical downlink control channel (PDCCH) and other control information, where n is equal to 0, 1, 2, 3 or 4; the remaining OFDM symbols may be used for transmitting a physical downlink shared channel (PDSCH) or an enhanced PDCCH (EPDCCH). In an LTE system, the PDCCH/EPDCCH is used for bearing downlink control information (DCI) that is used for distributing uplink channel resources or downlink channel resources, referred to as DL Grant and UL Grant, respectively. Grants of different UE are sent separately, and the DL Grant and the UL Grant are sent separately.

In an enhanced system of the LTE system, a larger operating bandwidth is obtained by combining a plurality of cell carriers (CC), i.e., carrier aggregation (CA), to form an uplink and a downlink of a communication system, thereby providing a higher transmission rate. Here, a plurality of cell carriers aggregated together may employ a same duplex mode, that is, the cells are all FDD cells or all TDD cells. There may be FDD cells and TDD cells simultaneously. For UE, a base station may configure the UE to work in a plurality of cells, one of which is a primary cell (Pcell) while the other cells are secondary cells (Scell). For an LTE CA system, the transmission of HARQ-ACK and CSI information based on PUCCH transmission is performed in the Pcell only.

### DISCLOSURE OF INVENTION

### Technical Problem

To satisfy the demands for the increased mobile communication traffic, it is required to explore more spectrum resources. A possible solution is to deploy the LTE system on an unlicensed band. Generally, the unlicensed band has been distributed for some other purposes, for example, radar or wireless fidelity (WiFi) in 802.11. Thus, on the unlicensed band, the level of interference has uncertainty. Consequently, it is usually difficult to ensure the quality of service (QoS) of the LTE transmission. However, the unlicensed band may still be used for data transmission with low QoS requirement. Here, the LTE system deployed on the unlicensed band is called an LTE-U system. On the unlicensed band, how to avoid the mutual interference between the LTE-U system and wireless systems such as radar or WiFi becomes a technical problem to be solved.

### Solution to Problem

The present application provides a method for data transmission on an unlicensed band, comprising the steps of:

receiving, by user equipment (UE), configuration information, the configuration information configuring a cell where the UE works on an unlicensed band; and

receiving, by the UE, control information, and performing data transmission on the unlicensed band according to the control information.

The method may further comprise the step of: when detecting that a wireless channel is idle, sending a wireless fidelity (WiFi) frame, and setting a duration field of the WiFi frame as a time period for reserving the wireless channel; and

the performing data transmission on the unlicensed band is specifically as follows: performing data transmission on the unlicensed band within the time period for reserving the wireless channel.

Preferably, the receiver address of the WiFi frame is different from the address of a WiFi station (WiFi STA).

The method may further comprise the step of: when detecting that a wireless channel is idle, sending a signal structure containing a physical layer convergence protocol (PLCP) preamble, a PLCP header and valid data transmission in accordance with 802.11, wherein the coding rate (RATE) and length (LENGTH) in the PLCP header indicate a time period for reserving the wireless channel; and

the performing data transmission on the unlicensed band is specifically as follows: performing data transmission on the unlicensed band within the time period for reserving the wireless channel.

Preferably, the performing data transmission on the unlicensed band is specifically as follows: reserving a wireless channel, and performing data transmission within the time period for reserving the wireless channel, and not performing data transmission at an interval between two times of reservation of the wireless channel.

Preferably, the performing data transmission on the unlicensed band comprises: in a part of subframes of a cell on the unlicensed band, reserving a wireless channel first, and then performing data transmission within the time period for reserving the wireless channel; and, in another part of subframes of the cell on the unlicensed band, performing data transmission in a power less than a preset power.

Preferably, the UE obtains, by a PDCCH in a primary cell (Pcell), a time period for reserving the wireless channel in the cell on the unlicensed band;

wherein, the UE works in the Pcell and the cell on the unlicensed band in a carrier aggregation (CA) mode.

The method may further comprise the step of: performing carrier sensing from moment T-T0, where T is a moment intended for data transmission in the cell, and T0 is a time advance for carrier sensing; and

the performing data transmission on the unlicensed band is specifically as follows: starting sending a signal at a corresponding moment, when detecting a wireless channel is idle and a preset condition is satisfied.

Preferably, T0 is equal to the time of one orthogonal frequency division multiplexing (OFDM) symbol.

Preferably, the preset condition is that it is detected that a wireless channel is idle before moment T, the corresponding moment is moment T; or

where the preset condition is that the idle duration of the wireless channel is equal to the time length TL, the corresponding moment is a moment when the idle duration of the wireless channel is equal to TL; or

where the preset condition is that the idle duration of the wireless channel reaches the time length TL and the wireless channel remains idle within a backoff time generated at random, the corresponding moment is a moment when the backoff time is over; or

where the preset condition is that when it is detected that the moment when the wireless channel becomes idle is prior to moment T while the time point after superimposed by a time length TL falls behind moment T, and the wireless channel remains idle until moment T, the corresponding moment is moment T; or

where the preset condition is that the idle duration of the wireless channel reaches the time length TL, the time point when the idle duration reaches the length of DIFS is prior to moment T, and that the time point after superimposed by a backoff time generated at random falls behind moment T, and the wireless channel remains idle until moment T, the corresponding moment is moment T;

wherein, TL is a fixed time length.

Preferably, if the corresponding moment falls behind moment T, the method further comprises the step of: starting sending a fill-in signal from the corresponding moment, and transmitting only a complete OFDM symbol in the rear part of a subframe; and

the performing data transmission on the unlicensed band is specifically as follows: starting sending valid data from the boundary of the OFDM symbol.

Preferably, if the corresponding moment is prior to moment T, the method further comprises the step of: starting sending a fill-in signal from the corresponding moment till moment T; and

the performing data transmission on the unlicensed band is specifically as follows: starting sending valid data from moment T.

Preferably, moment T-T0 is an starting position of the last OFDM symbol of each subframe; or

moment T-T0 is an starting position of the first OFDM symbol of each subframe; or

moment T-T0 is an starting position of the last OFDM symbol of the last subframe within a Pms cycle; or

moment T-T0 is an starting position of the first OFDM symbol of the first subframe within a Pms cycle;

where, P is a cycle parameter.

The method may further comprise the step of: preferably scheduling a physical resource block (PRB) in the effective bandwidth of the cell, overlapped with a guard band in the WiFi system, when performing data transmission on the unlicensed band.

The method may further comprise the step of: during scheduling, not scheduling a PRB in the vicinity of a pilot subcarrier of WiFi system; or, scheduling a PRB in the vicinity of the pilot subcarrier of WiFi system in a power less than a preset power.

Preferably, the UE acquires, by a downlink control information (DCI) format in the Pcell, whether a cell on the unlicensed band performs data transmission within a current cycle; or, the UE acquires, by the DCI in the Pcell, the number of wireless frames or the number of subframes used by the cell on the unlicensed band for data transmission within a cycle P;

wherein, the UE works in the Pcell and the cell on the unlicensed band in a CA mode, and the UE performs downlink transmission in the cell on the unlicensed band only.

Preferably, the UE acquires, by the DCI format in the Pcell, that the cell on the unlicensed band performs data transmission within the current cycle according to a configuration of uplink/downlink subframe distribution, or that the resources of the cell on the unlicensed band are not used for data transmission within the current cycle; or, the UE acquires, by the DCI in the Pcell, the number of wireless frames or the number of subframes used by the cell on the unlicensed band for data transmission within a cycle P;

wherein, the UE works in the Pcell and the cell on the unlicensed band in a CA mode, and the cell on the unlicensed band is semi-statically configured with an uplink/downlink subframe distribution.

Preferably, the UE acquires, by the DCI format in the Pcell, the configuration of uplink/downlink subframe distribution followed by the cell on the unlicensed band within the current cycle, or that the resources of the cell on the unlicensed band are not used for data transmission within the current cycle, or that all subframes of the cell on the unlicensed band are used for downlink transmission within the current cycle;

wherein, the UE works in the Pcell and the cell of the unlicensed band in a CA mode, and the uplink/downlink subframe distribution of the cell on the unlicensed band is dynamically configured.

Preferably, the performing data transmission on the unlicensed band comprises:

by the UE, when scheduled to perform uplink transmission, performing uplink transmission in an uplink subframe according to the uplink scheduling, whether the wireless channel is idle or not; or

by the UE, when scheduled to perform uplink transmission, detecting the state of the wireless channel before a corresponding uplink subframe, performing uplink transmission in the uplink subframe if the signal level of the wireless channel is lower than a preset threshold; or otherwise, skipping this time of uplink transmission.

Preferably, the performing uplink transmission in an uplink subframe comprises: by the UE, when scheduled to perform uplink transmission in a subframe n, if the UE has sent an uplink signal in a subframe n−1, continuing performing uplink transmission in the subframe n; and if the UE has not send any uplink signal in the subframe n−1, performing carrier sensing at first, and then performing uplink transmission in the subframe n when the signal level of the wireless channel is lower than a preset threshold.

The method may further comprise the steps of: when receiving a PDCCH order from a base station and triggering a physical random access channel (PRACH) transmission, detecting, by the UE, the state of the wireless channel before a subframe with the corresponding PRACH resources or within X ms in the front of the subframe,

by the UE, not responding to the PDCCH order if the wireless channel is busy; or

by the UE, not sending a PRACH preamble on the PRACH resources when the wireless channel is busy, continuing attempting the subsequent PRACH resources until available PRACH resources are found, and sending a PRACH preamble on the available PRACH resources; or

by the UE, detecting the state of the wireless channel within a time window, and not responding to the PDCCH order when there is no available PRACH resource found in the time window.

The method may further comprise the steps of:

by the UE, for one PRACH resource, performing carrier sensing within a preset time period prior to a subframe with the PRACH resource and within X ms in the front of the subframe with the PRACH resource; or, for one PRACH resource, performing carrier sensing only within X ms in the front of the subframe with the PRACH resource; and

by the UE, sending a PRACH preamble when the UE detects that the wireless channel is idle and the preset condition is satisfied.

Preferably, the preset condition is that the UE detects that the wireless channel is busy; or that the wireless channel is idle and remains idle within the time length TL, TL being a fixed time length.

Preferably, if the moment satisfying the preset condition is prior to the boundary of the subframe, the method further comprises the steps of: by the UE, sending a fill-in signal to the boundary of the subframe, and then starting sending a PRACH preamble.

Preferably, if the moment satisfying the preset condition falls behind the boundary of the subframe, the method further comprises the steps of: by the UE, truncating a front part of the PRACH preamble and then sending the truncated PRACH preamble.

Preferably, if the moment satisfying the preset condition falls behind the boundary of the subframe, the method further comprises the step of: by the UE, sending a complete PRACH preamble.

The present application further provides UE for data transmission on an unlicensed band, comprising:

a configuration module, configured to receive configuration information and configure, according to the configuration information, a cell where the UE works on an unlicensed band; and

a transmission module, configured to receive control information and perform data transmission on the unlicensed band according to the control information.

The present application further provides a method for data transmission on an unlicensed band, applied to a base station to which a cell on the unlicensed band belongs, comprising the steps of:

sending, by the base station, control information to UE, the control information being used for controlling the data transmission of the UE on an unlicensed band; and

performing, by the base station and the UE, data transmission on the unlicensed band.

The method may further comprise the steps of: when detecting that a wireless channel is idle, sending a WiFi frame and setting a duration field of the WiFi frame as a time period for reserving the wireless channel; or, when detecting that a wireless channel is idle, sending a signal structure containing a PLCP preamble, a PLCP header and valid data transmission in accordance with 802.11, wherein the rate and length in the PLCP header indicate the time period for reserving the wireless channel; and

the performing data transmission on the unlicensed band is specifically as follows: performing data transmission on the unlicensed band within the time period for reserving the wireless channel.

The present application further provides a base station for data transmission on an unlicensed band, comprising:

a control module, configured to send control information to UE, the control information being used for controlling the data transmission of the UE on an unlicensed band; and

a transmission module, configured to perform, together with the UE, data transmission on the unlicensed band.

By the technical solutions provided by the present invention, a wireless channel may be reserved for the data transmission of UE on an unlicensed band, and the data transmission of the UE on the unlicensed band and the frequency occupation of a WiFi system are coordinated, so that the mutual interference between the data transmission of the UE on the unlicensed band and the WiFi system is avoided.

### Advantageous Effects of Invention

The present application discloses a method and equipment for data transmission on an unlicensed band based on a long term evolution (LTE) system, to avoid the mutual interference between an LTE-U system and a WiFi system.

### BRIEF DESCRIPTION OF DRAWINGS

FIG. 1 is a structure of an LTE FDD frame;

FIG. 2 is a structure of an LTE TDD frame;

FIG. 3 is a basic flowchart of a method for data transmission on an unlicensed band according to the present application;

FIG. 4 is a schematic diagram of reserving a wireless channel based on a WiFi frame;

FIG. 5 is a structure diagram of a CTS frame;

FIG. 6 is a structure diagram of a PLCP frame of 802.11;

FIG. 7 is a schematic diagram of reserving a wireless channel based on a PLCP header;

FIG. 8 is a schematic diagram of reserving a wireless channel periodically;

FIG. 9 is a schematic diagram of reserving a wireless channel periodically and low-power LTE-U transmission;

FIG. 10 is a schematic diagram 1 of an LTE-U signal;

FIG. 11 is a schematic diagram 2 of an LTE-U signal;

FIG. 12 is a structure diagram 1 of an LTE-U subframe;

FIG. 13 is a structure diagram 2 of an LTE-U subframe;

FIG. 14 is a schematic diagram of a guard band of WiFi;

FIG. 15 is a schematic diagram of guard bands of WiFi and an LTE-U;

FIG. 16 is a schematic diagram of a PRACH signal;

FIG. 17 is a structural composition diagram of preferred UE according to the present application; and

FIG. 18 is a structural composition diagram of a preferred base station according to the present application.

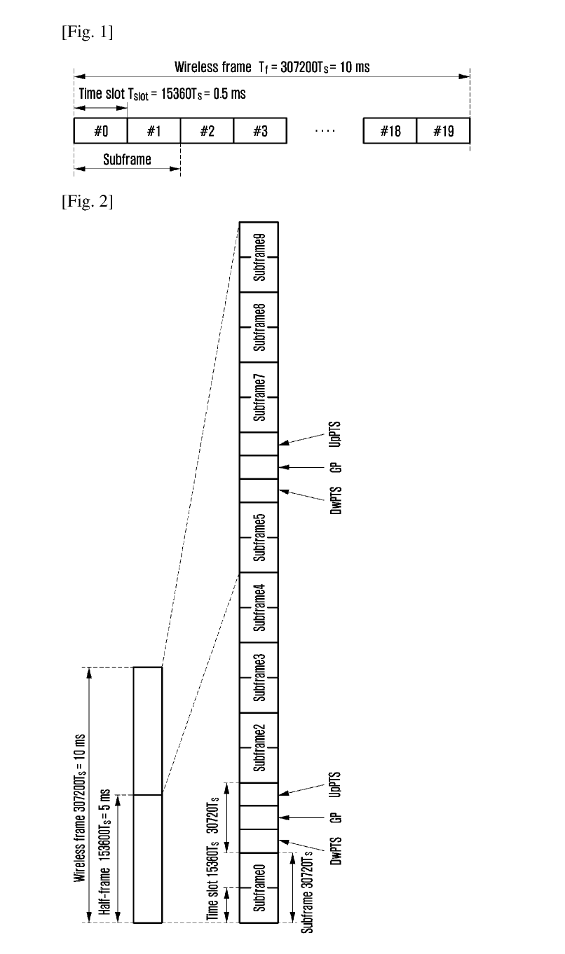

### MODE FOR THE INVENTION

To make the objectives, technical solutions and advantages of the present application clearer, the present application will be further described as below in details with reference to the accompanying drawings by embodiments.

Generally, an unlicensed band has been distributed for some other purposes, for example, wireless local area network (WiFi) in 802.11. In order to deploy an LTE-based system on an unlicensed band and avoid the mutual interference between this system and wireless systems such as radar or WiFi, it is required to perform corresponding adjustments on the LTE system. Hereinafter, the LTE-based system deployed on an unlicensed band is called an LTE-U system, and a corresponding cell is called an LTE-U cell.

On an unlicensed band, as the interference from other systems is uncontrollable, it is difficult to ensure the quality of service (QoS) of the LTE-U. A solution is to configure UE to work in a CA mode, where Pcell is a cell on the licensed band, while Scell may be configured as an LTE-U cell. Thus, the quality of service of the UE may be ensured by operations of the Pcell, and a larger transmission rate of the UE is supported by the LTE-U Scell.

FIG. 3 is a basic flowchart of a method for data transmission on an unlicensed band according to the present application. The method is applied to the UE side, and includes the following steps:

S301: UE receives configuration information, the information configuring a cell where the UE works on an unlicensed band.

Preferably, the UE may work in a CA mode according to the configuration of a base station and use an LTE-U cell as an Scell of the UE according to the configuration of the base station.

S302: The UE receives control information, and performs data transmission on the unlicensed band according to the control information.

Here, the UE may receive control information from a base station, for example, physical layer signaling in a Pcell, i.e., PDCCH. The control information is used for indicating whether an LTE-U cell is available for data transmission and further indicating a time length for LTE-U transmission. Data transmission in an LTE-U cell is hereinafter referred to as LTE-U transmission or LTE-U data transmission. When it is required to schedule uplink/downlink data transmission in an LTE-U cell, the scheduling may be cross-carrier scheduling. For example, the UE detects, in a Pcell, a PDCCH/EPDCCH for scheduling uplink/downlink data transmission in an LTE-U cell, and performs corresponding uplink/downlink data transmission. Alternatively, the scheduling may be self-scheduling. That is, the UE, in an LTE-U cell, detects a PDCCH/EPDCCH, and then performs corresponding uplink/downlink data transmission.

So far, the flow as shown in FIG. 3 ends.

Corresponding to the method as shown in FIG. 3, the present application correspondingly provides a method for data transmission on an unlicensed band. The method is applied to a base station to which a cell on the unlicensed band belongs. The method includes:

sending, by the base station, control information to UE, the control information being used for controlling the data transmission of the UE on an unlicensed band; and

performing, by the base station and the UE, data transmission on the unlicensed band.

The technical solutions of the present application will be further described as below in details by nine embodiments.

### Embodiment 1

A 802.11 system works on the basis of a carrier sense multiple access/collision avoidance (CSMA/CA) mechanism. A station (STA) must detect a wireless channel before sending signals. Only when the wireless channel is idle and maintained idle for a certain time period, the STA may occupy the wireless channel to send signals. Here, the STA may judge the state of a wireless channel by jointly using two mechanisms. On one hand, the STA may actually measure a wireless channel by the carrier sensing technology, and the STA considers that the wireless channel is busy when the signal of other STAs is detected or signal power exceeds a certain threshold; on the other hand, the virtual carrier sensing technology, i.e., a network allocation vector (NAV), has been introduced into the 802.11. Each 802.11 frame includes a duration field, and the value of the NAV is set according to the duration field. The NAV indicates a time period for reserving a wireless channel. That is, the STA cannot send signals on a wireless channel within the time period indicated by the NAV.

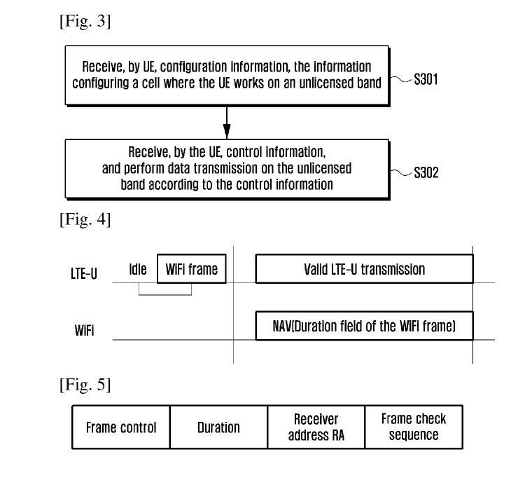

To realize the coexistence of an LTE-U system and a WiFi system and avoid the mutual interference therebetween, it is also required to introduce the carrier sensing technology into the LTE-U system. Thus, in the LTE-U system, as long as it is detected that the wireless channel is busy, the LTE-U equipment cannot send signals on the wireless channel, so that the mutual interference with the WiFi system is avoided. When the LTE-U equipment detects that the wireless channel is idle, as shown in FIG. 4, the LTE-U equipment may send a frame of a WiFi system according to WiFi standards at first, and sets the duration field of the WiFi frame as a time period for reserving the channel; then, after the STA of the WiFi system receives the WiFi frame, the STA sets the NAV according to the duration field in the WiFi frame, so that the STA will not send signals within a time period corresponding to the NAV, and the mutual interference between the LTE-U and the WiFi is thus avoided. Preferably, the WiFi frame for reserving the wireless channel sent in the LTE-U system may be a clear to send (CTS) frame or a request to send (RTS) frame. As both the CTS frame and the RTS frame in the WiFi system are used for reserving a wireless channel, the influence on the operation of the WiFi system may be minimized by using the two frames in the LTE-U. The above LTE-U equipment, which detects whether a wireless channel is idle at first before sending signals and then sends a WiFi frame for reserving the wireless channel, may be merely a base station. That is, the base station takes charge of detecting a WiFi signal and avoiding the collision with the WiFi transmission. Alternatively, the LTE-U equipment may also include a base station and UE simultaneously. That is, both the base station and the UE may detect a wireless channel, so as to avoid the collision with the WiFi. Here, the base station may configure some of UE to execute functions of detecting and reserving a wireless channel.

As shown in FIG. 5, a structure of a CTS frame in a WiFi system is shown, including: frame control, duration, receiver address (RA) and frame check sequence. The following will describe a method for setting various information fields of a CTS frame in an LTE-U system when reserving a wireless channel by a CTS frame.

The duration field may be set according to a time period for reserving the wireless channel, and may indicate a maximum reservation time period of 32.768 ms.

The receiver address (RA) field may be set as some special addresses different from the address of a common WiFi STA, so that it may be distinguished that this is a CTS frame sent by the LTE-U equipment. There may be the following ways for setup of the RA field:

1) The RA field may be set as a broadcast address, for example, with all bits of the RA field being “1”, or other broadcast or multicast addresses.

2) Each LTE-U equipment may be allocated with one WiFi address, so that the LTE-U equipment may set the RA field according to its own WiFi address when sending a CTS frame.

3) All LTE-U equipment may be allocated with a same WiFi address, so that all LTE-U equipment set the RA field by using this WiFi address when sending a CTS frame. The LTE-U equipment mentioned above may include a base station only, or include both a base station and UE.

4) Two WiFi addresses may be allocated for indicating a base station and UE, respectively, so that the base station and the UE set the RA field by using the corresponding WiFi addresses when sending a CTS frame.

5) The WiFi address used by UE may be configured by signaling sent by a base station. The signaling may be broadcast signaling or specific RRC signaling respectively sent to each UE. The WiFi address of a base station may be configured by other methods. Thus, the base station and the UE set the RA field by using the corresponding WiFi addresses when sending a CTS frame.

By the above various methods for setting the RA field, after a WiFi STA receives a CTS frame sent by LTE-U equipment, as the RA in the CTS frame is different from the address of a common STA, the STA may set the NAV according to the duration field in the CTS frame, avoiding sending signals within the duration indicated by the CTS frame. The UE may pay no attention to a CTS frame sent by other LTE-U equipment, and determine whether to send or receive data in an LTE-U cell according to an UL Grant and/or DL Grant sent by the base station; or, the UE may receive a CTS frame sent by other LTE-U equipment, and determine that the CTS frame is sent by other LTE-U equipment according to the RA field in the CTS frame, so that the LTE-U equipment may work within the duration indicated by the CTS frame according to the LTE mechanism. That is, the base station allocates resources and the UE receives or sends uplink/downlink data.

### Embodiment 2

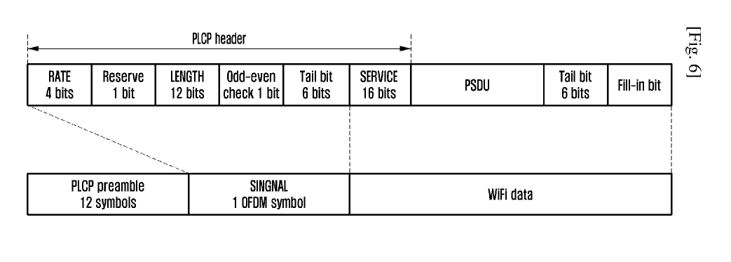

A 802.11 system works on the basis of a CSMA/CA mechanism. A station (STA) must detect a wireless channel before sending signals. Only when the wireless channel is idle and maintained idle for a certain time period, the STA may occupy the wireless channel to send signals. As shown in FIG. 6, a structure diagram of a protocol data packet of a physical layer convergence protocol (PLCP) of WiFi is shown. According to a time sequence, one data packet sent by the physical layer consists of a PLCP preamble, a PLCP header and WiFi data. Wherein:

The PLCP preamble is used for timing synchronization, etc.

The PLCP header contains some control information for decoding WiFi data, and particularly contains a coding rate (RATE) and a length (LENGTH). The RATE indicates the transmission rate of the data portion, and LENGTH indicates the number of bytes contained in a physical service data unit (PSDU). According to the RATE and LENGTH, a time period for occupying a wireless channel by the WiFi data transmission may be calculated, so that the STA may estimate the time length of the busy state of the wireless channel according to the RATE and LENGTH. Taking the minimum transmission rate of 6 Mbits/s in 802.11a as example, given the length of the LENGTH field is 12 bits, the maximum duration for occupying the wireless channel by one WiFi packet is about 5.46 ms.

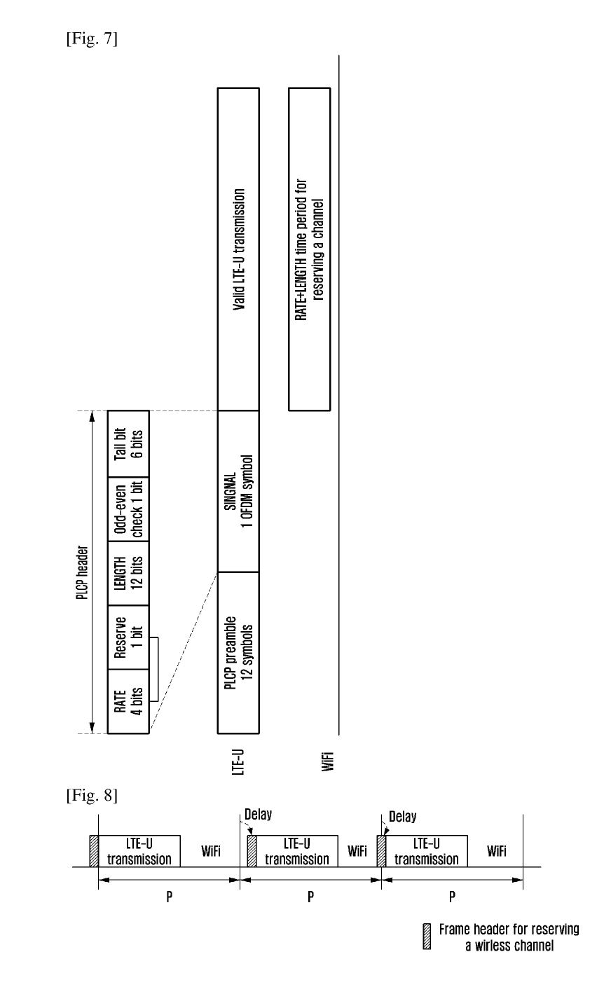

To realize the coexistence of an LTE-U system and a WiFi system and avoid the mutual interference therebetween, the present invention proposes that, in an LTE-U system, a wireless channel is reserved by using RATE and LENGTH in a PLCP header. In the LTE-U system, as long as it is detected that the wireless channel is busy, the LTE-U equipment cannot send signals on the wireless channel, so that the mutual interference with the WiFi is avoided. When the LTE-U equipment detects that the wireless channel is idle, as shown in FIG. 7, the LTE-U equipment may send a special signal structure. The signal structure includes a PLCP preamble, a PLCP header and valid LTE-U data transmission in accordance with 802.11. Here, the RATE and LENGTH in the PLCP header are set to indicate a time period for reserving a wireless channel. After receiving the signal structure, the STA of the WiFi system accomplishes synchronization according to the PLCP preamble and acquires RATE and LENGTH according to the PLCP header. Although the STA is unable to correctly decode the subsequent LTE-U data transmission, the STA may calculate a time period for occupying the wireless channel by the data transmission following the PLCP header according to the RATE and LENGTH in the PLCP header, so that the STA will not send signals within the time period, and the mutual interference between the LTE-U and the WiFi is avoided. Even in the case that the UE does not support the coding rate indicated by the RATE, the STA still can predict a time period for occupying the wireless channel by one frame on the basis of the RATE and LENGTH in the PLCP header. Therefore, by this method, the influence of the LTE-U transmission on the operation of the WiFi system may be reduced.

After acquiring the right of control of a wireless channel, a base station may send a PLCP preamble and a PLCP header according to the signal structure as shown in FIG. 7 so as to reserve the wireless channel, so that the STA in the WiFi system is avoided from occupying the channel within the time period indicated by the RATE and LENGTH, and the mutual interference is avoided. Within the time period indicated by the RATE and LENGTH, the STA may work according to the LTE mechanism. That is, the base station allocates resources, and the UE receives or sends uplink/downlink data.

The above LTE-U equipment, which detects whether a wireless channel is idle at first before sending signals and then sends a PLCP preamble and a PLCP header, may be merely a base station. That is, the base station takes charge of detecting a WiFi signal and avoiding the collision with the WiFi transmission. Alternatively, the LTE-U equipment may also include a base station and UE simultaneously. That is, both the base station and the UE may detect a wireless channel, so as to avoid the collision with the WiFi. Here, the base station may configure some of UE to execute functions of detecting and reserving a wireless channel.

Here, the base station may configure UE to send a structure of an uplink signal, i.e., possibly a signal structure as shown in FIG. 7. That is, the base station may configure the UE to send a PLCP preamble and a PLCP header at first and then valid LTE-U data. Alternatively, the UE may directly send the valid LTE-U data.

### Embodiment 3

On an unlicensed band, an LTE-U system may work in a manner of discontinuously occupying a wireless channel. That is, the LTE-U reserves the wireless channel for a time period when there are service requirements, and calculates a time length for reserving the wireless time according to the traffic requirements, so that the LTE-U transmission within this time period may be not influenced by WiFi. After the reservation time, the LTE-U stops transmitting signals on the wireless channel until a next time of reservation of the wireless channel. Here, when it is required to occupy a wireless channel, the LTE-U system may detect the state of the wireless channel at first, and then reserve the wireless channel by methods provided by Embodiment 1 or Embodiment 2 when the wireless channel is idle, so that the mutual interference with a WiFi system is avoided. Between two times of operations for reserving a wireless channel by the LTE-U, there may be a period of time unavailable for LTE-U transmission. This time period may be set aside for other wireless systems, for example, a WiFi system.

As shown in FIG. 8, the LTE-U system may periodically detect the wireless channel in P ms cycle. At moments being integral multiples of the P ms cycle, the wireless channel may have been occupied by the WiFi system. In order to avoid the mutual interference with the WiFi system, the LTE-U equipment may try to reserve the wireless channel after the WiFi system has accomplished data transmission and it is detected that the wireless channel is idle. Therefore, the starting time when the LTE-U system actually occupies the wireless channel may be delayed. The parameter P may be predefined, or sent to the UE by high-level signaling. The high-level signaling may be broadcast signaling or RRS signaling special for the UE.

Within each cycle, the base station may inform the UE of the time period for reserving the wireless channel within the current cycle by signaling. For example, the signaling may be sent by a PDCCH in a Pcell. For example, the signaling may be sent at the starting of each cycle to indicate a set of subframes available for LTE-U transmission within the current cycle. To reduce the number of times of blind detection, the DCI format on the PDCCH may reuse the number of bits of the DCI format 1A or 1C. Here, a certain RNTI may be configured for a group of UE or all UE, to indicate that the DCI format is intended to indicate a time period for reserving the wireless channel. Alternatively, for the above method, it may be unnecessary to indicate the time length reserved for LTE-U transmission within one cycle, and the UE just needs to detect UL Grant and DL Grant. For example, the UE detects, in a Pcell, UL Grant and DL Grant used for scheduling data transmission in an LTE-U cell, and then correspondingly performs uplink/downlink transmission.

### Embodiment 4

On an unlicensed band, subframe resources occupied by an LTE-U system may be classified into two types:

In a part of subframes, a wireless channel may be reserved by a certain method, for example, by the method described in Embodiment 1 or Embodiment 2, to avoid the mutual interference with a WiFi system. Correspondingly, in this part of subframes, the LTE-U equipment may also work in a large transmit power.

In the other part of subframes, the LTE-U system may directly transmit signals of LTE instead of reserving a wireless channel. However, the LTE-U system may work in a low power only, to reduce the influence on the WiFi transmission. In this part of subframes, as the transmit power of the LTE-U equipment is low, interference signals received by the STA not so close to a base station and the UE are weak, so that WiFi transmission may be performed on the wireless channel. Here, the maximum value of the transmit power of the LTE-U equipment may be configured by high-level signaling, such as broadcast signaling or RRC signaling respectively sent to each UE.

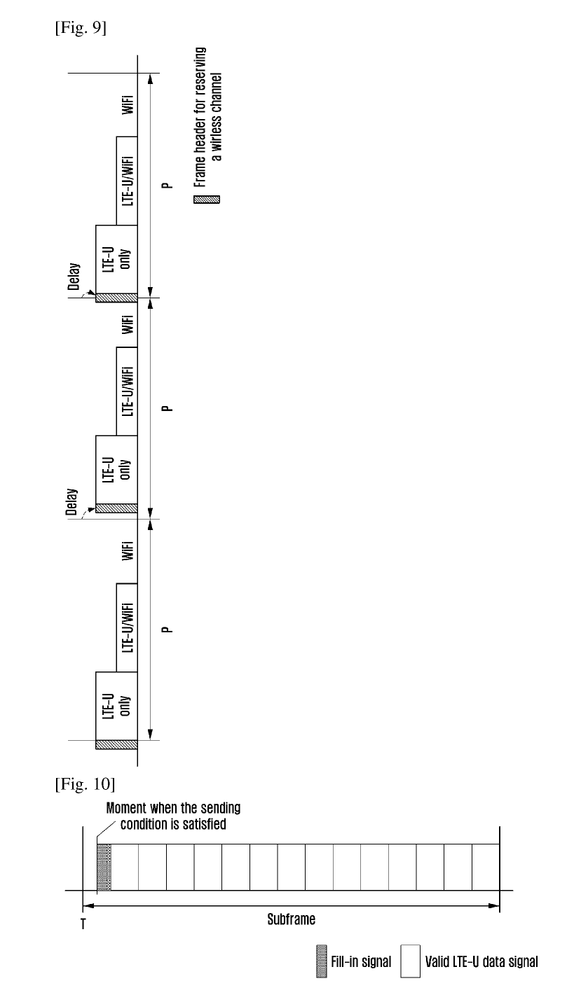

As shown in FIG. 9, the LTE-U system may periodically detect the wireless channel in P ms cycle. At moments being integral multiples of the P ms cycle, the wireless channel may have been occupied by the WiFi system. In order to avoid the mutual interference with the WiFi system, the LTE-U equipment may try to reserve the wireless channel after the WiFi system has accomplished data transmission and it is detected that the wireless channel is idle. Therefore, the starting time when the LTE-U system actually occupies the wireless channel may be delayed. After the time period of reserving a wireless channel special for LTE-U transmission, the LTE-U equipment may transmit LTE-U signals in a low power within a period of time, without needing to reserve the wireless channel; within this time period, there may be WiFi transmission simultaneously in a neighbor region. Finally, before the start of LTE-U transmission requiring a next time of reservation of the wireless channel, there may be a period of time unavailable for the LTE-U system. This time period may be set aside for other wireless systems, for example, a WiFi system.

Similar to Embodiment 3, the parameter P may be predefined, or sent to the UE by high-level signaling. The high-level signaling may be a broadcast signaling or a RRS signaling special for the UE.

Within each cycle, the base station may inform the UE of the time period for reserving the wireless channel and the time period for transmission with low power within the current cycle by signaling. For example, the signaling may be sent by a PDCCH in a Pcell. For example, the signaling may be sent at the starting of each cycle to indicate a set of subframes available for LTE-U transmission within the current cycle. To reduce the number of times of blind detection, the DCI format on the PDCCH may reuse the number of bits of the DCI format 1A or 1C. Here, a certain RNTI may be configured for a group of UE or all UE, to indicate that the DCI format is intended to indicate a time period for reserving the wireless channel. Alternatively, for the above method, it may be unnecessary to indicate the time length reserved for LTE-U transmission within one cycle, and the UE just needs to detect UL Grant and DL Grant. For example, the UE detects, in a Pcell, UL Grant and DL Grant used for scheduling data transmission in an LTE-U cell, and then correspondingly performs uplink/downlink transmission.

### Embodiment 5

In an LTE system, wireless resources are divided into fixed frame structures, and each subframe has its own fixed starting time position. Thus, when LTE-U equipment and an STA compete for a channel based on carrier sensing, if the current wireless channel has been occupied by WiFi, the LTE-U equipment has to wait. Consequently, the time when the LTE-U equipment may actually use the wireless resources may be inconsistent with the fixed subframe division.

When the LTE-U equipment needs to perform LTE-U transmission at moment T, where, T is a starting moment of one LTE-U frame, or T is a starting moment of one LTE-U subframe. The present invention proposes that the LTE-U equipment perform carrier sensing in advance for a time period T0, i.e., from moment T-T0. Once finding that the channel is idle and a certain condition is satisfied, the LTE-U equipment may start sending signals. For example, the time advance T0 may be a constant. For example, T0 is equal to the time of one OFDM symbol; or, T0 may also be a number related to the implementation of the LTE-U equipment.

Where the condition may be that the LTE-U equipment finds that a channel is idle before moment T. In this case, the LTE-U equipment starts to occupy the channel from moment T.

Or, where the above condition may be that the LTE-U equipment finds that a channel is idle and the idle duration reaches a certain time length TL, the LTE-U equipment starts to occupy the channel from the moment when the idle duration of the channel is equal to TL, TL being a fixed time length. For example, TL may be equal to the length of Short Inter Frame Spacing (SIFS), Point Inter Frame Spacing (PIFS) or Distributed Inter Frame Spacing (DIFS) in the 802.11.

Or, where the condition may be that, when the LTE-U equipment finds that the idle duration of the channel reaches a certain time length TL, a backoff time is generated at random, and the wireless channel remains idle within the backoff time, the LTE-U equipment may start to occupy the channel when the backoff time is over.

Or, where the condition may be that the LTE-U equipment finds that the moment when the wireless channel becomes idle is prior to moment T while the time point after superimposed by a certain time length TL falls behind moment T, and the wireless channel remains idle until moment T, the LTE-U equipment may still start to occupy the channel from moment T.

Or, where the condition may be that the LTE-U equipment finds that the channel is idle and the moment point when the idle duration reaches a certain time length TL is prior to moment T, and that the time point after superimposed by the backoff time falls behind moment T, and the wireless channel remains idle until moment T, the LTE-U equipment may still start to occupy the channel from moment T.

According to the above carrier sensing and the conditions for sending signals, when the LTE-U may send signals, it may transmit valid LTE signals not from moment T. For example, the moment satisfying the carrier sensing and the condition of sending signals has fallen behind moment T; or, by taking Embodiment 1 as example, the WiFi frame to be sent by the LTE-U equipment for reserving a wireless channel may be finished after moment T, so that the transmission of valid LTE signals is influenced. In this way, for a first subframe after moment T, the period of time before this first subframe cannot be used for normal LTE-U data transmission. As shown in FIG. 10, a moment when the valid LTE-U data may be transmitted may not be the boundary of an OFDM symbol. If a wireless channel has been reserved, the LTE-U equipment may delete first several influenced OFDM symbols of a subframe, and transmit only complete OFDM symbols in the rear part of the subframe. Or, if a wireless channel has not been reserved, in order to occupy the channel, the LTE-U equipment may be required to send a fill-in signal to occupy the channel until the uninfluenced and complete OFDM symbols may be sent. Here, if more than n OFDM symbols are unavailable for LTE-U transmission in one subframe, for example, n is equal to 1, 2 or 3, the whole subframe is not used for LTE-U transmission, or the first frame after moment T is not used for LTE-U transmission.

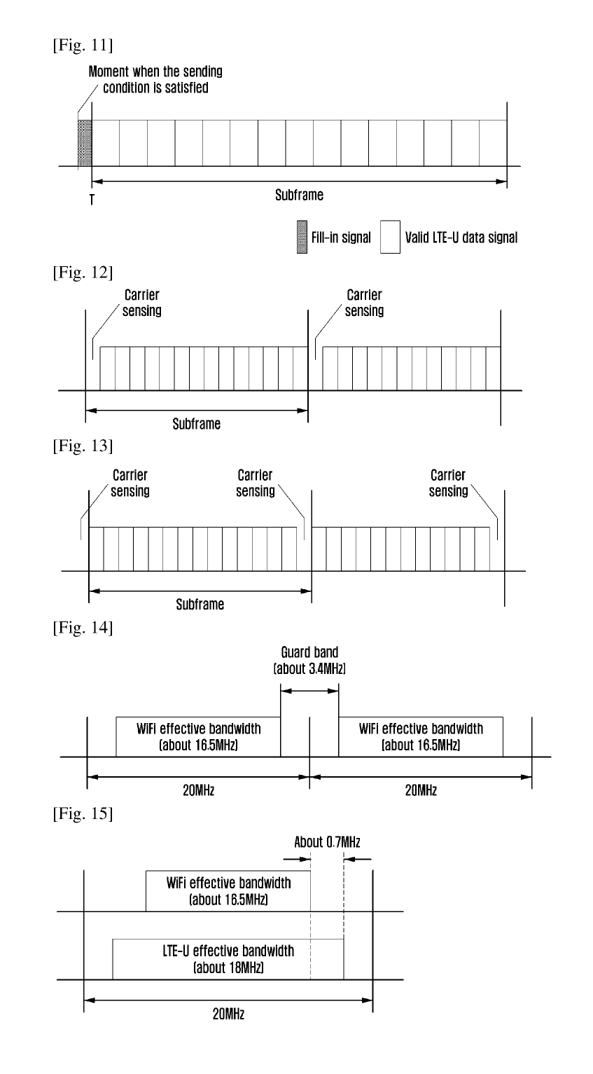

According to the above carrier sensing and the conditions of sending signals, it is also possible that the LTE-U equipment may transmit LTE signals before moment T. However, due to the limitation of the frame structure, valid LTE signals still need to be sent at moment T. if a wireless channel has been reserved, the LTE-U equipment may wait and start to send the valid LTE-U signals at moment T, without worrying that the channel will be occupied by an STA. For example, in the method of Embodiment 1, after sending a CTS frame, the LTE-U equipment stops transmitting signals, waits and starts to send valid LTE-U signals at moment T; and in the method of Embodiment 2, after sending a PLCP preamble and a PLCP header, the LTE-U equipment stops sending signals, waits and starts to send valid LTE-U signals at moment T. If a wireless channel has been reserved, the LTE-U equipment may also send some fill-in signals to actually occupy the wireless channel. For example, in the method of Embodiment 1, after sending a CTS frame, the LTE-U equipment starts to send fill-in signals, and starts to send valid LTE-U signals from moment T; and in the method of Embodiment 2, after sending a PLCP preamble and a PLCP header, the LTE-U equipment starts to send fill-in signals, and starts to send valid LTE-U signals from moment T. If a wireless channel has not been reserved, as shown in FIG. 11, once the carrier sensing and the conditions of sending signals are satisfied, the LTE-U equipment may send fill-in signals to actually occupy the wireless channel, and start to send valid LTE-U signals from moment T.

Based on the above method, on an unlicensed band, in order to support carrier sensing, a base station needs to stop downlink transmission at some specific moments, and then executes carrier sensing. Correspondingly, the frame structure of an LTE system will be influenced.

The LTE-U equipment may perform carrier sensing before sending data of each subframe, and can occupy a channel to send LTE-U data of this subframe only when the wireless channel is idle and the certain condition is satisfied. As shown in FIG. 12, a subframe structure supporting carrier sensing is shown. Here, the last OFDM symbol of each subframe is deleted, so that the LTE-U equipment may perform carrier sensing in this OFDM symbol. When it is detected that a carrier is idle and the certain condition is satisfied, the first 13 OFDM symbols of the subframe may be used for sending LTE-U signals. Or, as shown in FIG. 13, another subframe structure supporting carrier sensing is shown. Here, the first OFDM symbol of each subframe is deleted, so that the LTE-U equipment may perform carrier sensing in this OFDM symbol. When it is detected that a carrier is idle and the certain condition is satisfied, the last 13 OFDM symbols of the subframe may be used for sending LTE-U signals.

The LTE-U equipment may also perform one time of carrier sensing every P ms, and can occupy a channel to perform LTE-U transmission only when the wireless channel is idle and a certain condition is satisfied. In order to perform carrier sensing, a base station needs to stop downlink transmission to monitor the channel every P ms. For example, the last OFDM symbol of a previous subframe may be deleted every P ms, for purpose of carrier sensing; or, the first OFDM of one subframe may be deleted every P ms, for purpose of carrier sensing. The parameter P may be predefined, or sent to the UE by high-level signaling. The high-level signaling may be broadcast signaling or RRS signaling special for the UE.

### Embodiment 6

In accordance with 802.11, WiFi signals are sent on the whole bandwidth, and there is a time division multiplexing relation between signals sent by different STAs. However, an LTE system supports division and allocation of frequency resource in granularity of PRBs. Furthermore, the two systems occupy a bandwidth 20 MHz, but the bandwidths actually occupied by the two systems are different. The effective bandwidth of the LTE system is about 18 MHz, taking 802.11a as example, and the actually occupied bandwidth is about 16.5 MHz.

As shown in FIG. 14, taking 802.11a as example, between two adjacent bandwidths 20 MHz, there is a guard band about 3.4 MHz, equivalent to the frequency domain widths of 19 PRBs in the LTE system. At the frequency of the guard band, the WiFi system actually does not transmit useful signals. Assumed that LTE-U signals are transmitted on the guard band, for an LTE-U system, WiFi interference signals are result from signal leakage on the effective WiFi bandwidth; while for a WiFi system, if LTE-U signals are transmitted on the guard band, the interference of the LTE-U system to the WiFi system is also resulted from signal leakage. The mutual interference resulted from signal leakage is much smaller than simultaneous transmission of LTE-U signals and WiFi signals at a same frequency. According to the above analysis, a base station may adjust the center frequency position of the LTE-U according to the channel actually occupied by the nearby WiFi system, so that the effective bandwidth of the LTE-U may cover the guard band. As the LTE system supports PRB-based scheduling, there is very small mutual interference between the LTE-U system and the WiFi system when the base station schedules a PRB on the guard band.

As shown in FIG. 15, assumed that the center frequency of the WiFi system is aligned to the center frequency of the LTE-U system, as the effective bandwidth of the LTE-U system is larger than that of the WiFi system, there may still be some PRBs of the LTE-U which are overlapped with the frequency of the guard band of the WiFi system, so that the scheduling on these PRBs has small interference to the LTE-U system. There are about 8 PRBs in FIG. 15. According to the above analysis, when the center frequency of the WiFi is aligned to the center frequency of the LTE-U, a base station may still preferably schedule PRBs on the guard band, and the mutual interference between LTE-U and WiFi is small.

By the above method, when the LTE-U transmission is performed on an unlicensed band, PRBs in the effective bandwidth of the LTE-U, overlapped with the guard band of the WiFi system, may be preferably scheduled, so that the mutual interference with the WiFi system is reduced.

In addition, in accordance with 802.11, some specific subcarriers are used as pilots. Taking 802.11a as example, in addition to the DC component, an OFDM signal is divided into 52 subcarriers, four of which are used as pilots, i.e., subcarriers −21, −7, 7 and 21, respectively. To reduce the interference of LTE-U signals to the WiFi system, during scheduling in LTE-U, PRBs in the vicinity of a pilot subcarrier of WiFi may be not scheduled; or, PRBs in the vicinity of the pilot subcarrier of WiFi may be scheduled in a low power. By this method, the interference to WiFi pilot signals is reduced and the precision of channel estimation is improved, so that it is advantageous to ensure the performance of the WiFi system.

### Embodiment 7

An LTE-U cell may be merely used as one Scell of UE. In this case, indication information about resource occupancy of the LTE-U cell may be sent in a Pcell. The indication information may be sent in the Pcell in Pms cycle. For example, the resource occupancy of an LTE-U Scell within a cycle is indicated by DCI information carried in a PDCCH/EPDCCH. Specifically, the cycle P may be equal to 10 ms, so that the indication information is sent in each wireless frame of the Pcell.

For the first case, it is assumed that LTE-U Scell is applicable to LTE-U downlink transmission only.

Assumed that an LTE-U Scell is merely used for LTE-U downlink transmission, 1-bit information may be carried in a DCI format in the Pcell. That is, it is indicated that the LTE-U cell is actually used for LTE-U transmission within the current cycle, or the resources of an LTE-U Scell within the current cycle are not used for LTE-U transmission.

Or, assumed that an LTE-U Scell is merely used for LTE-U downlink transmission, DCI in a Pcell indicates the number of wireless frames available for LTE-U transmission within cycle P in the LTE-U Scell. Specifically, the number 0 of frames represents that the resources of the current LTE-U Scell within the current cycle are not used for LTE-U transmission. Or, the DCI in the Pcell may indicate the number of subframes available for LTE-U transmission within cycle P. If k bits are used for indicating information about the LTE-U Scell, one k-bit code word, such as code word 0, indicates that the resources of the LTE-U Scell within the current cycle are not used for LTE-U transmission; while the other code words indicate the number of subframes possible for LTE-U transmission. For example, the mth code word indicates the number of subframes, starting from the front, available for LTE-U transmission in the └(m·P)/(2^{k}−1)┘, where m=0, 1, 2, . . . 2^{k}−1.

Or, assumed that an LTE-U Scell is merely used for LTE-U downlink transmission, the number of frames, starting from the current subframe, continuously available for LTE-U transmission in the LTE-U Scell may be indicated by a DCI format sent in a Pcell in cycle Q; or, the number of subframes, starting from the current subframe, continuously available for LTE-U transmission in the LTE-U Scell may be indicated by a DCI format sent in the Pcell in cycle Q. After receiving a new DCI format indicating the LTE-U resources, the UE updates the information about the available LTE-U resources with the number of frames or subframes indicated by the new DCI format. If more frames or subframes are indicated in the new DCI, the UE knows that the LTE-U transmission may be performed in more frames or subframes; and if less frames or subframes are indicated in the new DCI, the UE knows that the frames or subframes available for LTE-U transmission decrease.

For the second case, it is assumed that LTE-U Scell may support both LTE-U uplink transmission and LTE-U downlink transmission, and that the LTE-U Scell is semi-statically configured with an uplink/downlink subframe distribution. For example, the uplink/downlink subframe distribution may be one of the existing seven TDD uplink/downlink configurations. However, the present invention will not limit the above uplink/downlink subframe distribution in a structure having a cycle of 10 ms only. A method for sending in Pcell indication information about resources occupied by the LTE-U cell in this case will be described as below.

1-bit information may be carried in a DCI format in a Pcell. That is, it is indicated that it works according to the uplink/downlink subframe distribution of the LTE-U Scell, or the resources of the LTE-U Scell within the current cycle are not used for LTE-U transmission.

Or, DCI in the Pcell may indicate the number of wireless frames available for LTE-U transmission in the LTE-U Scell within cycle P. Particularly, the number 0 of frames represents that the resources of the current LTE-U Scell within the current cycle are not used for LTE-U transmission. Or, the DCI in the Pcell may indicate the number of subframes available for LTE-U transmission within the cycle P. If k bits are used for indicating information about the LTE-U Scell, one k-bit code word indicates that the resources of the LTE-U Scell within the current cycle are not used for LTE-U transmission; while the other code words indicate the number of subframes possible for LTE-U transmission. For example, the mth code word indicates the number of subframes, starting from the front, available for LTE-U transmission in the LTE-U Scell within one cycle: └(m·P)/(2^{k}−1)┘, where m=0, 1, 2, . . . 2^{k}−1.

Or, the number of frames, starting from the current subframe, continuously available for LTE-U transmission in the LTE-U Scell may be indicated by a DCI format sent in a Pcell in cycle Q; or, the number of subframes, starting from the current subframe, continuously available for LTE-U transmission in the LTE-U Scell may be indicated by a DCI format sent in the Pcell in cycle Q. After receiving a new DCI format indicating the LTE-U resources, the UE updates the information about the available LTE-U resources with the number of frames or subframes indicated by the new DCI format. If more frames or subframes are indicated in the new DCI, the UE knows that the LTE-U transmission may be performed in more frames or subframes; and if less frames or subframes are indicated in the new DCI, the UE knows that the frames or subframes available for LTE-U transmission decrease.

For the third case, it is assumed that the LTE-U Scell may support both LTE-U uplink transmission and LTE-U downlink transmission, that the LTE-U Scell supports a plurality of uplink/downlink subframe distributions, and that which uplink/downlink subframe distribution is actually used by the LTE-U Scell may be dynamically variable. For example, the uplink/downlink subframe distributions may be the existing seven TDD uplink/downlink configurations or a subset thereof. However, the present invention will not limit the above uplink/downlink subframe distributions in a structure having a cycle of 10 ms only. A method for sending in Pcell indication information about resources occupied by the LTE-U cell in this case will be described as below.

Assumed that the uplink/downlink subframe distribution actually used by the LTE-U Scell is dynamically variable, the DCI format in the Pcell may be used for indicating the following conditions: the LTE-U Scell works according to an uplink/downlink subframe distribution within the current cycle, or the resources of the LTE-U Scell within the current cycle are not used for LTE-U transmission. For example, for each LTE-U Scell, 7 existing TDD uplink/downlink configurations and a case where the current LTE-U Scell is completely unavailable for LTE-U transmission may be distinguished by three bits.

Or, the DCI format in the Pcell may be used for indicating the following conditions: the LTE-U Scell works according to an uplink/downlink subframe distribution within the current cycle, or the resources of the LTE-U Scell within the current cycle are not used for LTE-U transmission, or all subframes of the LTE-U Scell within the current cycle are used for LTE-U downlink transmission. If there is a limitation that only six of seven existing TDD configurations are available, there are totally eight types of possible subframe distributions, and the subframe distribution of an LTE-U cell may still be indicated by three bits.

For the dynamically variable uplink/downlink subframe distribution used by the LTE-U Scell, the DCI of the Pcell may further indicate the number of frames or subframes for LTE-U transmission within the current cycle, in addition to the currently used uplink/downlink subframe distribution.

### Embodiment 8

It is assumed that uplink transmission may be performed in an LTE-U Scell. For example, the LTE-U Scell may allocate uplink/downlink resources according to a TDD uplink/downlink configuration. In an LTE system, the PUSCH transmission in an uplink subframe is scheduled by a UL Grant.

For an LTE-U Scell, there may be two methods for uplink transmission:

One method: as long as the LTE-U schedules uplink transmission, UE will send uplink signals in an uplink subframe at a corresponding timing position, whether a wireless channel is idle or not.

Another method: when the LTE-U schedules uplink transmission, the UE detects the state of a wireless channel before a corresponding uplink subframe; if the signal level of the wireless channel is lower than a preset threshold, the UE sends signals in the uplink subframe; or otherwise, the UE skips this time of uplink signal transmission. Here, the threshold may be predefined or configured by a base station to UE by high-level signaling. Here, the threshold may be configured by high-level signaling, for example, broadcast signaling, or RRC signaling respectively sent to each UE.

The UE may be configured to perform uplink transmission according to any one of the above two methods. Or, in order to provide the scheduling flexibility of a base station, the UL Grant may be added with 1-bit information indicating the UE to work according to one of the above two methods.

For uplink transmission, another processing method is as follows: when receiving that a base station schedules uplink transmission in a subframe n, if the UE has sent an uplink signal in a subframe n−1, including the case of sending an SRS on the last symbol of the subframe n−1, the UE may continue the uplink transmission in the subframe n; and if the UE has not send any uplink signal in the subframe n−1, the UE needs to perform carrier sensing at first before performing uplink transmission in the subframe n, and then may send an uplink signal in the subframe n only when the signal level of the wireless channel is lower than a certain threshold.

Here, for the closed-loop power control based on accumulated TPC, the UE may accumulate the received TPC commands to each uplink subframe; or, if one time of uplink transmission is skipped because the channel is busy, the UE may not accumulate the TPC command in this time.

In the method of the embodiment, the UE could detect the state of a wireless channel in the whole LTE-U bandwidth, or, the UE could also detect the state of a wireless channel in the frequency position corresponding to the PRB resource of the PUSCH which is allocated to the UE by base station.

### Embodiment 9

An LTE-U system on an unlicensed bandwidth and an LTE system on a licensed bandwidth are located on different bands. For example, the LTE-U system is located on a 5 GHz band, while the LTE system may be located on a 900 MHz or 2 GHz band. The huge difference in frequency results in different propagation characteristics. As a result, the uplink timing in the LTE-U may be different from the uplink timing in the LTE. In this case, to realize uplink synchronization in the LTE-U system, UE needs to trigger a PRACH process.

Similar to the LTE system, the RPACH resources in the LTE-U system may be semi-statically configured by high-level signaling. When receiving a PDCCH order from a base station and triggering a PRACH transmission, with respect to one selected PRACH resource, the UE may detect the state of a wireless channel before a subframe with the corresponding PRACH resources or within X ms in the front of the subframe, and may send a PRACH preamble only when it is detected that the wireless channel is idle at a certain moment within this time period and that a certain condition is satisfied. “before a subframe with the corresponding PRACH resources” means that, the UE may detect the state of a wireless channel before the starting of timing of the subframe with the corresponding PRACH resources; “within X ms in the front of the subframe” means that, within the subframe with the corresponding PRACH resources, within a period of time X ms in length from the starting of timing of this subframe. The UE may start to perform carrier sensing at a moment prior to the subframe with the PRACH resources, and the carrier sensing may be continued till X ms in the front of the subframe with the PRACH resources if the channel is busy. When the UE detects that the wireless channel is idle at a certain moment within this time period and a certain condition is satisfied, the UE may send a PRACH permeable. The condition for detecting whether the wireless channel is idle may be that: the UE may send a PRACH permeable immediately once detecting that the wireless channel is idle; or, the UE may start to send a PRACH permeable after detecting that the wireless channel is idle and remains idle within a certain time length TL, TL being a fixed time length. For example, TL may be equal to the length of Short Inter Frame Spacing (SIFS), Point Inter Frame Spacing (PIFS) or Distributed Inter Frame Spacing (DIFS) in the 802.11. If the wireless channel is busy, the UE does not send a PRACH preamble on the PRACH resource, and will not respond to this PRACH order any more. Alternatively, if the wireless channel is busy, the UE does not send a PRACH preamble on the PRACH resource, instead, continues attempting the subsequent PRACH resources; and, the UE sends a PRACH preamble on a corresponding PRACH channel until detecting that the wireless channel is idle at a certain moment before a subframe with the PRACH resources or within X ms in the front of the subframe and a certain condition is satisfied. Further, a time window may be set, that is, the UE can detect a channel and find available PRACH resources within this time window only. When detecting that the wireless channel is idle at a certain moment before a subframe with the PRACH resources or within X ms in the front of the subframe and a certain condition is satisfied, the UE sends a PRACH preamble on a corresponding PRACH channel. When there is no available PRACH resource found in the time window, the UE does not respond to the PDCCH order any more.

In addition, when an LTE-U cell may exist as only an Scell in a CA system, the PRACH transmission in the LTE-U Scell is triggered by the PDCCH order in the Pcell. When a base station is not going to send any PDCCH order, it is unnecessary to reserve any PRACH resource. Therefore, another method for distribution of PRACH resources is that: according to the received PDCCH order, based on a certain timing relation, the UE may regard that PRACH resources have been distributed to one or more subframes. In this view, the UE may attempt to perform carrier sensing. When detecting that the carrier is idle before a subframe with the PRACH resources or at a certain moment within X ms in the front of the subframe, the UE sends a PRACH preamble on the corresponding PRACH resources. For example, the PDCCH order is recorded as in a subframe n, the timing relation is delay k, and only one subframe is distributed with PRACH resources, the PRACH resources are located in an uplink subframe n+k; when detecting that the carrier is idle before a subframe with the PRACH resources or at a certain moment within X ms in the front of the subframe, the UE sends a PRACH preamble, or otherwise the UE does not send a PRACH preamble. Alternatively, the set of time differences between the set of the subframes distributed with the PRACH resources and the subframe n is recorded as K, K including time differences between each subframe distributed with the PRACH resources and the subframe n, the UE may try each PRACH resource on the uplink subframe set n+K; the UE sends a PRACH preamble on the PRACH resource until detecting that the carrier is idle before a subframe with the PRACH resources or at a certain moment within X ms in the front of the subframe and that a certain condition is satisfied; and if failing to detect any available PRACH resource in the set K, the UE does not send a PRACH preamble.

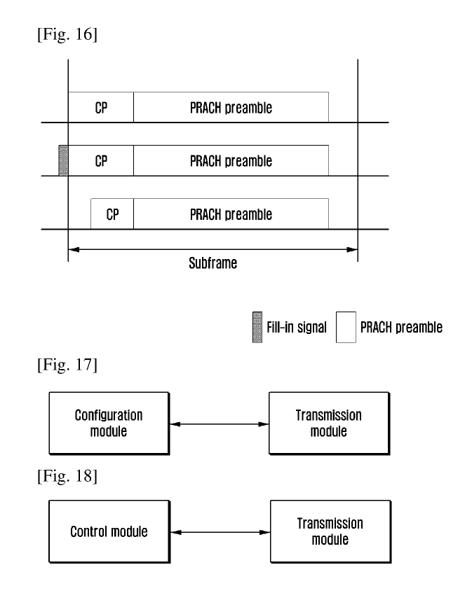

FIG. 16 shows a possible signal form of a PRACH preamble sent by UE. Ideally, the PRACH preamble is sent from the boundary of a subframe. However, the UE may start to detect a wireless channel before the boundary of the subframe with the PRACH preamble; and the moment, when the UE detects that the wireless channel is idle and a certain condition is satisfied so that the UE may send signals, may be prior to the boundary of the subframe. In this case, to occupy the channel, the UE needs to send a fill-in signal to the boundary of the subframe, so that the UE may start to send a PRACH preamble from the boundary of the subframe. Particularly, the fill-in signal may be a further extension of the CP part of the PRACH preamble. That is, the fill-in signal is cascaded with the existing CP, equivalently adding a longer CP to the valid PRACH sequence.

Actually, the LTE-U is usually a small cell, and the CP length of the PRACH preamble far exceeds the actual demand. Therefore, another method for processing a PRACH preamble is as follows: when receiving a PDCCH order from a base station and triggering a PRACH transmission, for one PRACH resource, the UE may perform carrier sensing from a moment prior to a subframe with the PRACH, and the carrier sensing may be continued till X ms in the front of the subframe with the PRACH if a channel is busy; or, for one PRACH resource, the UE may perform carrier sensing from the boundary of the subframe with the PRACH, and the carrier sensing may be continued till X ms in the front of the subframe with the PRACH if a channel is busy; and when the UE detects that the wireless channel is idle at a certain moment within this time period and a certain condition is satisfied, the UE may send the PRACH preamble.

If the moment when the UE may send signals is prior to the boundary of the subframe, in order to occupy the channel, the UE needs to send a fill-in signal so that the PRACH preamble may be sent from the boundary of the subframe. If the moment when the UE detects that the wireless channel is idle and the certain condition is satisfied has been within the subframe with the PRACH, it is required to truncate the front part of the PRACH preamble. Equivalently, the CP length of the PRACH preamble is reduced. The boundary moment when a downlink subframe receives timing is recorded as T1, the moment when the UE detects that the wireless channel is idle and a certain condition is satisfied delays for a time length Δ with respect to the boundary where the downlink subframe receives timing, a time length Δ of the front part of the PRACH preamble is truncated. That is, the CP length of the PRACH preamble is reduced by Δ. The UE starts to send the truncated PRACH preamble from moment T1+Δ. By this method, the valid PRACH sequence in the truncated PRACH preamble sent by the UE may be kept consistent with the complete PRACH preamble sent on the boundary of the subframe in terms of timing position, thereby not influencing the estimation of the base station on the TA of the UE. The X ms is less than the CP length of the PRACH preamble. In the most extreme case, the CP needs to be truncated by X ms. As the LTE-U is suitable for a small cell, the reduction of the CP length will not influence the actual PRACH performance. However, the selection of X needs to ensure that the PRACH preamble still has enough remaining CP to resist against propagation delay and other non-ideal factors.

Alternatively, if the moment when the UE detects that the wireless channel is idle and a certain condition is satisfied has been within the subframe with the PRACH, the UE may still send a complete PRACH preamble, i.e., a PRACH preamble including a complete CP part and a PRACH sequence part. That is, the moment when the UE sends a PRACH preamble is not the boundary where the downlink subframe receives timing. This is different from the way of sending the PRACH preamble in an existing LTE system. The boundary moment when a downlink subframe receives timing is recorded as T1, the moment when the UE detects that the wireless channel is idle and a certain condition is satisfied delays for a time length Δ with respect to T1, so the UE starts to send the PRACH preamble at moment T1+Δ. After receiving the PRACH preamble, the LTE-U base station sets the TA in an RACH Response (RAR) still assuming that the UE sends the PRACH preamble at moment T1, and the corresponding time length of the TA is recorded as TTA. The TA sent by the base station is generally increased, because the time length Δ in which the UE delays to send the PRACH preamble will be processed as propagation delay increase on the base station side. Therefore, the LTE-U base station can not use the TA as the accurate indication information about the propagation delay of the UE. After receiving the TA, as the UE accurately knows that it send the PRACH preamble after a delay of Δ, i.e., at moment T1+Δ, the UE may perform correction with Δ according to the received TA. For example, the value of TA actually needed by the UE is TTA-2Δ. In this way, the UE may still perform the transmission of uplink signals according to the actually needed value of TA (TTA-2Δ).

In the method of the embodiment, the UE could detect the state of a wireless channel in the whole LTE-U bandwidth, or, the UE could also detect the state of a wireless channel in the frequency position corresponding to the PRB resource of the PRACH preamble.

Corresponding to the method applied on the UE side, the present application further discloses user equipment for data transmission on an unlicensed band. As shown in FIG. 17, the equipment includes a configuration module and a transmission module, wherein:

the configuration module is configured to receive configuration information and configure, according to the configuration information, a cell where the equipment works on an unlicensed band; and

the transmission module is configured to receive control information and perform data transmission on the unlicensed band according to the control information.

Corresponding to the method applied on the base station side, the present application further discloses a base station for data transmission on an unlicensed band. As shown in FIG. 18, the base station includes:

a control module, configured to send control information to UE, the control information being used for controlling the data transmission of the UE on an unlicensed band; and

a transmission module, configured to perform, together with the UE, data transmission on the unlicensed band.

The above descriptions are merely preferred embodiments of the present application, and are not intended to limit the present application. Any modification, equivalent replacement and improvement made within the spirit and principle of the present application shall fall into the protection scope of the present application.

1. A method for data transmission on an unlicensed band, comprising the steps of:
receiving, by a UE, configuration information, the configuration information configuring a cell where the UE works on an unlicensed band; and
receiving, by the UE, control information, and performing data transmission on the unlicensed band according to the control information.

2. The method according to claim 1, characterized in that,
the method further comprises the step of: when detecting that a wireless channel is idle, sending a wireless fidelity (WiFi) frame, and setting a duration field of the WiFi frame as a time period for reserving the wireless channel; and
the performing data transmission on the unlicensed band is specifically as follows: performing data transmission on the unlicensed band within the time period for reserving the wireless channel,
wherein a receiver address of the WiFi frame is different from an address of a WiFi station (WiFi STA).

3. (canceled)

4. The method according to claim 1, characterized in that,
the method further comprises the step of: when detecting that a wireless channel is idle, sending a signal structure containing a physical layer convergence protocol (PLCP) preamble, a PLCP header and valid data transmission in accordance with 802.11, wherein a coding rate (RATE) and a length (LENGTH) in the PLCP header indicate a time period for reserving the wireless channel; and
the performing data transmission on the unlicensed band is specifically as follows: performing data transmission on the unlicensed band within the time period for reserving the wireless channel,
the performing data transmission on the unlicensed band is specifically as follows: reserving a wireless channel, and performing data transmission within the time period for reserving the wireless channel, and not performing data transmission at an interval between two times of reservation of the wireless channel,
the performing data transmission on the unlicensed band comprises: in a part of subframes of a cell on the unlicensed band, reserving the wireless channel first and then performing data transmission within the time period for reserving the wireless channel; and, in another part of subframes of the cell on the unlicensed band, performing data transmission in a power less than a preset power.

5. (canceled)

6. (canceled)

7. The method according to claim 4, characterized in that,
the UE obtains, by a physical downlink control channel (PDCCH) in a primary cell (Pcell), a time period for reserving the wireless channel in the cell on the unlicensed band;
wherein, the UE works in the Pcell and the cell on the unlicensed band in a carrier aggregation (CA) mode.

8. The method according to claim 1, characterized in that,
the method further comprises the step of: performing carrier sensing from moment T-T0, where T is a moment intended for data transmission in the cell, and T0 is a time advance for carrier sensing; and
the performing data transmission on the unlicensed band is specifically as follows: starting sending a signal at a corresponding moment, when detecting a wireless channel is idle and a preset condition is satisfied.

9. The method according to claim 8, characterized in that,
T0 is equal to a time of one orthogonal frequency division multiplexing (OFDM) symbol,
moment T-T0 is a starting position of a last OFDM symbol of each subframe; or
moment T-T0 is a starting position of a first OFDM symbol of each subframe; or
moment T-T0 is a starting position of a last OFDM symbol of a last subframe within Pms cycle; or
moment T-T0 is a starting position of a first OFDM symbol of a beginning subframe within Pms cycle;
where, P is a cycle parameter.

10. The method according to claim 8, characterized in that,
where the preset condition is that it is detected that a wireless channel is idle before moment T, the corresponding moment is moment T; or
where the preset condition is that an idle duration of the wireless channel is equal to a time length TL, the corresponding moment is a moment when the idle duration of the wireless channel is equal to TL; or
where the preset condition is that the idle duration of the wireless channel reaches the time length TL and the wireless channel remains idle within a backoff time generated at random, the corresponding moment is a moment when the backoff time is over; or
where the preset condition is that when it is detected that a first time point when the wireless channel becomes idle is prior to moment T while the first time point after being superimposed by a time length TL falls behind moment T, and the wireless channel remains idle until moment T, the corresponding moment is moment T; or
where the preset condition is that the idle duration of the wireless channel reaches the time length TL, a second time point when the idle duration reaches the time length TL is prior to moment T, the second time point after being superimposed by a backoff time generated at random falls behind moment T, and the wireless channel remains idle until moment T, the corresponding moment is moment T;
wherein, TL is a fixed time length.

11. The method according to claim 10, characterized in that,
if the corresponding moment falls behind moment T, the method further comprises the step of: starting sending a fill-in signal from the corresponding moment, and transmitting only a complete OFDM symbol in a rear part of a subframe; and
the performing data transmission on the unlicensed band is specifically as follows: starting sending valid data from a boundary of the OFDM symbol.

12. The method according to claim 10, characterized in that,
if the corresponding moment is prior to moment T, the method further comprises the step of: starting sending a fill-in signal from the corresponding moment until moment T; and
the performing data transmission on the unlicensed band is specifically as follows: starting sending valid data from moment T.

13. (canceled)

14. The method according to claim 1, characterized in that,
the method further comprises the step of: preferably scheduling a physical resource block (PRB) in an effective bandwidth of the cell, overlapped with a guard band in a WiFi system, when performing data transmission on the unlicensed band,
the method further comprises the step of during scheduling, not scheduling a PRB in a vicinity of a pilot subcarrier of the WiFi system; or, scheduling a PRB in the vicinity of the pilot subcarrier of the WiFi system in a power less than a preset power,
the UE acquires, by a downlink control information (DCI) format in a primary cell (Pcell), whether a cell on the unlicensed band performs data transmission within a current cycle; or, the UE acquires, by the DCI in the Pcell, a number of wireless frames or a number of subframes used by the cell on the unlicensed band for data transmission within a cycle P;
wherein, the UE works in the Pcell and the cell on the unlicensed band in a CA mode, and the UE performs downlink transmission in the cell on the unlicensed band only.

15. (canceled)

16. (canceled)

17. The method according to claim 1, characterized in that,
the UE acquires, by a DCI format in a primary cell (Pcell), that the cell on the unlicensed band performs data transmission within a current cycle according to a configuration of uplink/downlink subframe distribution, or that resources of the cell on the unlicensed band are not used for data transmission within the current cycle; or, the UE acquires, by the DCI format in the Pcell, a number of wireless frames or a number of subframes used by the cell on the unlicensed band for data transmission within a cycle P;
wherein, the UE works in the Pcell and the cell on the unlicensed band in a CA mode, and the cell on the unlicensed band is semi-statically configured with an uplink/downlink subframe distribution,
the UE acquires, by the DCI format in the Pcell, the configuration of uplink/downlink subframe distribution followed by the cell on the unlicensed band within the current cycle, or that the resources of the cell on the unlicensed band are not used for data transmission within the current cycle, or that all subframes of the cell on the unlicensed band are used for downlink transmission within the current cycle;
wherein, the UE works in the Pcell and the cell of the unlicensed band in a CA mode, and the uplink/downlink subframe distribution of the cell on the unlicensed band is dynamically configured.

18. (canceled)

19. The method according to claim 1, characterized in that the performing data transmission on the unlicensed band comprises:
by the UE, when scheduled to perform uplink transmission, performing uplink transmission in an uplink subframe according to uplink scheduling, whether a wireless channel is idle or not; or
by the UE, when scheduled to perform uplink transmission, detecting a state of the wireless channel before a corresponding uplink subframe, performing uplink transmission in the uplink subframe if a signal level of the wireless channel is lower than a preset threshold; or otherwise, skipping this time of uplink transmission.

20. The method according to claim 19, characterized in that,
the performing uplink transmission in an uplink subframe comprises: by the UE, when scheduled to perform uplink transmission in a subframe n, if the UE has sent an uplink signal in a subframe n−1, continuing performing uplink transmission in the subframe n; and if the UE has not sent any uplink signal in the subframe n−1, performing carrier sensing first, and then performing uplink transmission in the subframe n when the signal level of the wireless channel is lower than a preset threshold.

21. The method according to claim 1, characterized in that the method further comprises the steps of: when receiving a PDCCH order from a base station and triggering a physical random access channel (PRACH) transmission, detecting, by the UE, a state of a wireless channel before a subframe with corresponding PRACH resources or within X ms in a front of the subframe,
by the UE, not responding to the PDCCH order if the wireless channel is busy; or
by the UE, not sending a PRACH preamble on the PRACH resources when the wireless channel is busy, continuing attempting subsequent PRACH resources until available PRACH resources are found, and sending a PRACH preamble on the available PRACH resources; or
by the UE, detecting the state of the wireless channel within a time window, and not responding to the PDCCH order when there is no available PRACH resource found in the time window.

22. The method according to claim 1, characterized in that the method further comprises the steps of:
by the UE, for one PRACH resource, performing carrier sensing within a preset time period prior to a subframe with the PRACH resource and within X ms in a front of the subframe with the PRACH resource; or, for one PRACH resource, performing carrier sensing only within X ms in the front of the subframe with the PRACH resource; and
by the UE, sending a PRACH preamble when the UE detects that a wireless channel is idle and a preset condition is satisfied.

23. The method according to claim 22, characterized in that,
the preset condition is that the UE detects that the wireless channel is busy; or that the wireless channel is idle and remains idle within a time length TL, TL being a fixed time length,
if a moment satisfying the preset condition is prior to a boundary of the subframe, the method further comprises the steps of: by the UE, sending a fill-in signal to the boundary of the subframe, and then starting sending a PRACH preamble,
if the moment satisfying the preset condition falls behind the boundary of the subframe, the method further comprises the steps of: by the UE, truncating a front part of the PRACH preamble and then sending the truncated PRACH preamble,
if the moment satisfying the preset condition falls behind the boundary of the subframe, the method further comprises the step of by the UE, sending a complete PRACH preamble.

24-26. (canceled)

27. UE for data transmission on an unlicensed band, comprising:
a configuration module, configured to receive configuration information and configure, according to the configuration information, a cell where the UE works on an unlicensed band; and
a transmission module, configured to receive control information and perform data transmission on the unlicensed band according to the control information.

28. A method for data transmission on an unlicensed band, applied to a base station to which a cell on the unlicensed band belongs, comprising the steps of:
sending, by the base station, control information to a UE, the control information being used for controlling the data transmission of the UE on an unlicensed band; and
performing, by the base station and the UE, data transmission on the unlicensed band.

29. The method according to claim 28, characterized in that,
the method further comprises the steps of: when detecting that a wireless channel is idle, sending a WiFi frame and setting a duration field of the WiFi frame as a time period for reserving the wireless channel; or,
when detecting that a wireless channel is idle, sending a signal structure containing a PLCP preamble, a PLCP header and valid data transmission in accordance with 802.11, wherein a rate and a length in the PLCP header indicate a time period for reserving the wireless channel; and
the performing data transmission on the unlicensed band is specifically as follows: performing data transmission on the unlicensed band within the time period for reserving the wireless channel.

30. A base station for data transmission on an unlicensed band, comprising:
a control module, configured to send control information to UE, the control information being used for controlling the data transmission of the UE on an unlicensed band; and
a transmission module, configured to perform, together with the UE, data transmission on the unlicensed band.
